(19) United States
(12) Patent Application Publication
(10) Pub. No.: US 2022/0299068 A1
(43) Pub. Date: Sep. 22, 2022

(54) CONSTANT VELOCITY JOINT COVER

(71) Applicant: Matthew Young, Wiscasset, ME (US)

(72) Inventor: Matthew Young, Wiscasset, ME (US)

(21) Appl. No.: 17/697,205

(22) Filed: Mar. 17, 2022

Related U.S. Application Data
(60) Provisional application No. 63/207,768, filed on Mar. 22, 2021.

(51) Int. Cl. F16D 3/84

(52) U.S. Cl. CPC F16D 3/845; F16D 2200/0056; F16D 2300/12

(57) ABSTRACT

A constant velocity joint cover that may be placed on and/or removed from a constant velocity joint without having to disassemble the corresponding axel assembly.

### BACKGROUND INFORMATION

### Field of the Invention

The invention relates to constant velocity joint covers for vehicles.

### Discussion of Prior Art

Constant-velocity joints, which are also known as homokinetic or CV joints, allow a drive shaft to transmit power through a variable angle at a constant rotational speed. Such CV joints are mainly used in front wheel drive vehicles, such as all-terrain vehicles, utility terrain vehicles, and automobiles. To protect the CV joint, a cover, often referred to as a “CV Boot”, is provided to keep lubricating substances in and around the CV joint and to keep dirt and water out.

While the CV Boots typically work well, they also have a tendency to rip, tear, or otherwise break in a manner that exposes at least some part of the CV joint to dirt and other substances that negatively impact both the performance and longevity of the CV joint.

The CV Boots are replaceable, however, replacing a conventional CV boot typically requires a mechanic who is able to completely disassemble the vehicle's axle assembly. This is a time consuming process for anyone to undertake, and typically too difficult for the average vehicle owner. However, there are great benefits from having a CV boot in good working condition, and replacing the CV boot more frequently generally leads to a longer lasting and better performing CV joint.

What is needed, therefore, is a constant velocity joint cover that is easy to replace.

### BRIEF SUMMARY OF THE INVENTION

The invention is a constant velocity (“CV”) joint cover (the “Replaceable “CV Boot”) that may be replaced without dissembling the associated axle assembly. To accomplish this function the Replaceable CV Boot has an opening on one side that is openable and closeable by a fastener, such as, for example, a zipper. In the case of a zipper embodiment, the zipper runs from top to bottom along a side portion of the Replaceable CV Boot. To secure the Replaceable CV Boot, the user simply unzips the zipper, places the open Replaceable CV Boot cover around the CV joint, and zips the zipper. Later, to replace the Replaceable CV Boot once it has worn the user simply unzips and removes the Replaceable CV Boot, and secures a new one in its place.

The Replaceable CV Boot may be made of a number of suitable materials that are conventionally known, such as, for example, a rubber, polyurethane, or neoprene. The zipper is conventional zipper but made of a number of suitably durable and non-corrosive materials, such as a nylon coil zipper or a stainless steel zipper. The zipper is integrated into the cover using a number of conventional methods, such as sewing.

It is also likely that clamps are used to further secure the Replaceable CV Boot in place. For example, conventional hose clamps or earless low profile clamps, with one positioned on either end of the Replaceable CV Boot. Finally, the Replaceable CV Boot may be constructed in a manner that may be “cut to fit”, meaning that it is provided in size that is large enough to work in conjunction with any conventional CV joint but that it may be physically cut to a smaller size to fit on smaller joints.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 illustrates the replaceable constant velocity joint cover secured to a constant velocity joint.

FIG. 2A illustrates the replaceable constant velocity joint cover in an open configuration.

FIG. 2B illustrates a first clamp.

FIG. 2C illustrates a second clamp.

FIG. 3 is a front plan view of the replaceable constant velocity joint cover.

FIG. 4 is a top plan view of the replaceable constant velocity joint cover.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

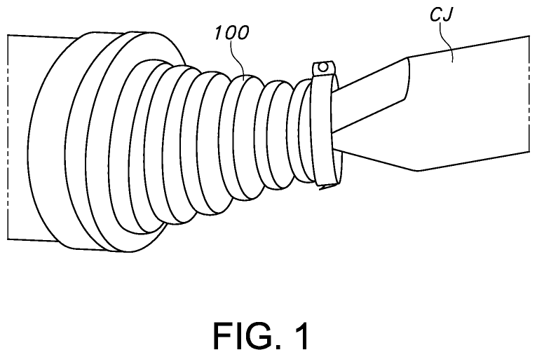

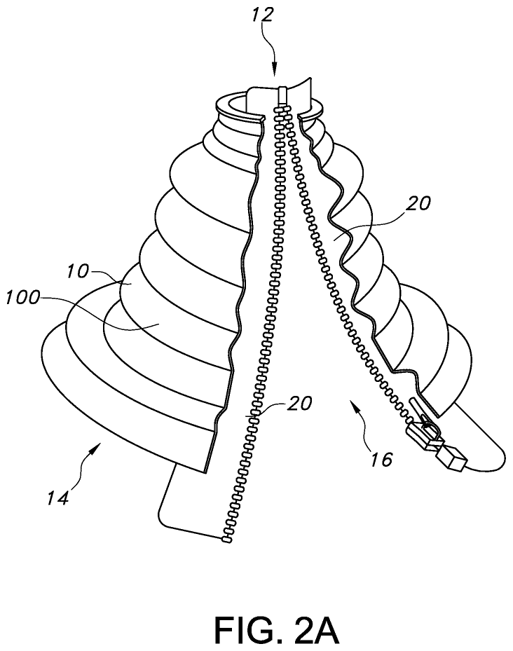

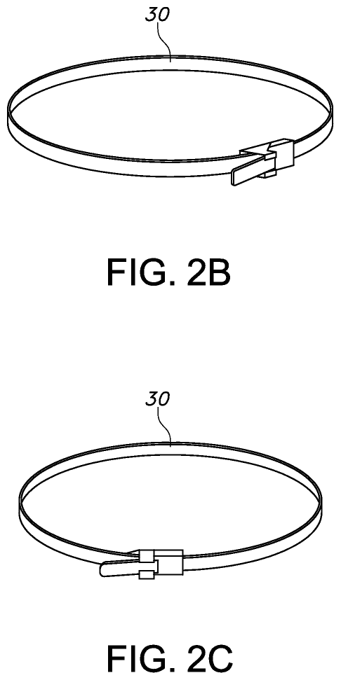

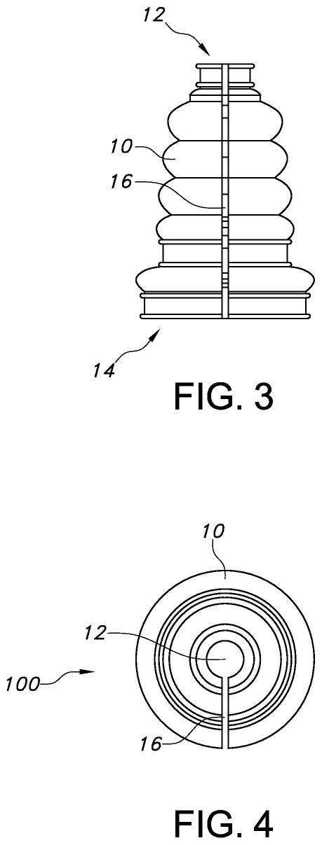

FIGS. 1-5 illustrate a replaceable constant velocity joint cover 100 (“Replaceable CV Boot”) according to the invention comprising, at least, a cover 10 that may be opened and closed by a fastener 20. The Replaceable CV Boot 100 is configured to cover a constant velocity joint (“CV Joint”) CJ on an automobile in a manner that is both quick and easy to secure and quick and easy to replace, in each instance without have to disassemble the associated axle assembly.

The cover 10 has an approximately conical shape that, with a first opening 12 on an upper end and a second opening 14 on a lower end, and is generally in the shape of a conventional CV Joint CJ such that it probably covers and protects the joint when secured in the proper position. The cover 10 has an opening 16 along a side of the cover 12 that runs from the first opening 12 to the second opening 14 such that the entire cover 10 may be pulled open.

The fastener 20 is attached to the cover 10 and configured to secure the cover 10 in a closed position and, alternatively, allow a user to easily open the cover from said closed position. For example, the fastener 20 may be in the form of a conventional zipper. Conventional zippers have two sides that come together to secure the zippered connection, and in this instance the two sides of the zipper 20 would be attached to the two sides of the opening 16, respectively.

In the case of a zipper embodiment, to secure the Replaceable CV Boot Cover 100, the user simply unzips the zipper 20, places the open Replaceable CV Boot Cover 100 around the CV joint, and zips the zipper. Later, to replace the Replaceable CV Boot Cover 100 once it has worn down the user simply unzips and removes the Replaceable CV Boot Cover 100 and secures a new one in its place.

The Replaceable CV Boot Cover 100 may be made of a number of suitable materials that are conventionally known, such as, for example, a rubber, polyurethane, or neoprene. When a zipper is used as a fastener it is a conventional zipper made from any number of suitably durable and non-corrosive materials, such as a nylon coil zipper or a stainless steel zipper. The zipper is integrated into the cover using a number of conventional methods, such as sewing.

It is also likely that clamps 30 are used to further secure the Replaceable CV Boot Cover 100 in place. For example, conventional hose clamps or earless low profile clamps, the clamps being used in a conventional manner. In particular, one clap 30 may be placed on each of the upper end and lower end of the Replaceable CV Boot Cover 100 after it is in the proper position around the CV joint.

The fastener may also come in other forms, for example, it could be in the form of ties or hook and loops.

Lastly, the Replaceable CV Boot Cover 100 may made in various sizes so that a user may choose the proper size for the intended CV Joint CJ, or it may be made in a manner that allows the user to cut the Replaceable CV Boot Cover 100 to fit the particular size of CV Joint CJ that needs to be covered. For example, it may be made in a size that is likely to be large enough to fit over any conventional CV joint and made of a material that is relatively easy to cut with conventional tools. Prior to installation the user may cut away the extra material, starting at one side of the fastener 20 and ending at the other side of the fastener 20, thereby leaving the entire fastener 20 intact. Or, the user may insert the entire Replaceable CV Boot Cover 100 over the CV joint CJ, secure it in place with the fastener 20 and the clamps 30 and then, with the clamps 30 securing Replaceable CV Boot Cover 100 in the desired location, cut away all of the extra material including the fastener 20.

It is understood that the embodiments described herein are merely illustrative of the present invention. Variations in the construction of the Replaceable CV Boot Cover may be contemplated by one skilled in the art without limiting the intended scope of the invention herein disclosed and as defined by the following claims.

What is claimed is:

1: A cover device adapted to be removably secured to a joint, the cover device comprising:
a cover that has a first opening on a top end, a second opening on a bottom end, and a third opening that extends from the first opening to the second opening along a side of the cover, the third opening having a first side and a second side;
a fastener that has a first fastener side and a second fastener side, the first fastener side attached to the third opening's first side, the second fastener side attached to the third opening's second side, the fastener configured to open and close the third opening;
wherein the cover is removably placeable around the joint where it is removeably secured in place by the fastener.

2: The cover device of claim 1, the fastener configured in the form of a zipper that opens and closes the third opening.

3: The cover device of claim 2, further including a first clamp and a second clamp, the first clamp adapted to further secure the first opening around the joint and the second clamp adapted to further secure the second opening around the joint.

4: The cover device of claim 2, the cover made from neoprene.

5: The cover device of claim 5, wherein the cover is adapted to be cut to fit the size of the joint.
